(19) United States
(12) Patent Application Publication
(10) Pub. No.: US 2009/0107731 A1
(43) Pub. Date: Apr. 30, 2009

(54) DRILLBIT SEAL

(76) Inventor: George Fedorovich, Nacogdoches, TX (US)

Correspondence Address: DON W. BULSON (PARK);RENNER, OTTO, BOISSELLE & SKLAR, LLP, 1621 EUCLID AVENUE / 19TH FLOOR, CLEVELAND, OH, 44115, US

(21) Appl. No.: 12/261,582

(22) Filed: Oct. 30, 2008

Related U.S. Application Data
(60) Provisional application No. 60/983,645, filed on Oct. 30, 2007.

(51) Int. Cl. E21B 10/25; F16J 15/16

(52) U.S. Cl. 175/372; 277/649

(57) ABSTRACT

A drillbit seal (60) comprises a rigid carrier (80), an elastomeric body (90), and a reinforcing band (100). The rigid carrier (80) has a seatside leg section (81) at least partially forming a rigid IBseat region (65) for static seating (e.g., metal-to-metal pressfit) in a seal-receiving envelope. The elastomeric body (90) at least partially forms a flexible IBspin region (67) with a lip (71) and a flexible OBspin region (68) with a lip (72). The band (100) forms a rigid bridge (73) between the spinside lips (71, 72) for reinforcement and prevention of pressure-induced deformation.

### RELATED APPLICATION

This application claims priority under 35 U.S.C. §119(e) to U.S. Provisional Patent Application No. 60/983,645 filed on Oct. 30, 2007, the entire disclosure of which is hereby incorporated by reference. If incorporated-by-reference subject matter is inconsistent with subject matter expressly set forth in the written specification (and/or drawings) of the present disclosure, the present disclosure governs to the extent necessary to eliminate indefiniteness and/or clarity-lacking issues.

### BACKGROUND

A drillbit can comprise a hub, at least one cutter rotatably mounted to the hub, and a bearing cavity therebetween. Interfacing surfaces of the hub and the cutter spin relative to each other and a seal-receiving envelope is situated between these surfaces. A seal is installed in this envelope and this seal has the significant job of preventing lubricant from escaping the bearing cavity while also preventing exterior fluid (e.g., drilling mud) from entering the bearing cavity. If a drillbit seal needs to be repaired/replaced during the drilling of an oil or gas wellbore, it can require tripping the entire drillstring (which can be tens of thousands of feet long and weigh several tons) and a substantial loss in production.

### SUMMARY

A drillbit seal comprises a rigid region forming a static seat against the floor of an envelope, flexible lipped regions compressed against and in consistent sealing contact with an interfacing spin surface, and a rigid region forming a reinforcing bridge between the spinside lips. These and other features of the seal are fully described and particularly pointed out in the claims. The following description and annexed drawings set forth in detail certain illustrative embodiments, these embodiments being indicative of but a few of the various ways in which the principles may be employed.

### DRAWINGS

FIG. 1 is a schematic view of a drilling operation.

FIG. 2 is a perspective view of a drillbit.

FIG. 3 is a cross-sectional view of a portion of the drilibit.

FIGS. 4A-4L are close-up cross-sectional views of possible forms of a seal-receiving envelope of the drillbit.

FIG. 5 is a close-up cross-sectional view of a drillbit seal.

FIG. 6 is a close-up cross-sectional view of another drillbit seal.

### DESCRIPTION

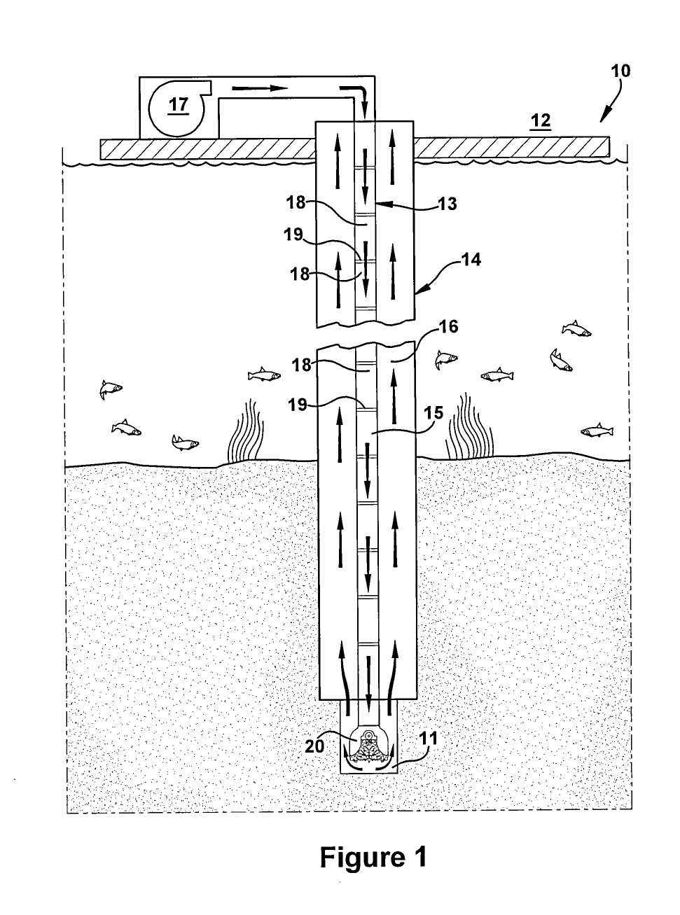

Referring now to the drawings, a drilling operation 10 is shown schematically in FIG. 1. The illustrated offshore operation 10 involves the drilling of an oil or gas wellbore 11 in the ocean floor with equipment controlled from a rig 12. This equipment can include, for example, a drillstring 13 extending from the rig 12 into the wellbore 11 and a riser 14 surrounding the drillstring 13. A drilling fluid (e.g., mud) is sent through a central passage 15 of the drillstring 13 and returned through an annular passage 16 formed by the riser 14. This pumping can be accomplished, for example, by a mudpump 17 on the rig 12.

The drillstring 13 typically comprises a plurality of string segments 18 (connected end-to-end by couplers 19) and a drillbit 20 attached to the end of the lowest segment 18. As the drillstring 13 is rotated, the drillbit 20 cuts away at earth matter within the wellbore 11 to dig it deeper. The cuttings resulting from this drilling process mix with the mud pumped through the drillstring 13 and return to or near the rig 12 through the riser passage 16.

As the wellbore 11 is being drilled deeper and deeper, string segments 18 are sequentially coupled on the rig 12 to the upper end of the drillstring 13. The reverse is done to remove the drillstring 13 from the wellbore 11 (i.e., string segments 18 are sequentially uncoupled), but without gravity doing any favors. A heavy hoist, able to lift the weight of the entire drillstring 13, is typically used to incrementally pull the drillstring 13 out of the wellbore 11 (e.g., about ninety feet at a time) so that a string segment 18 can be uncoupled. A drillstring 13 can have a length of tens of thousands of feet and/or it can weigh several tons. Accordingly, such a drillstring-disassembly process (commonly called “tripping”) is not a trivial job.

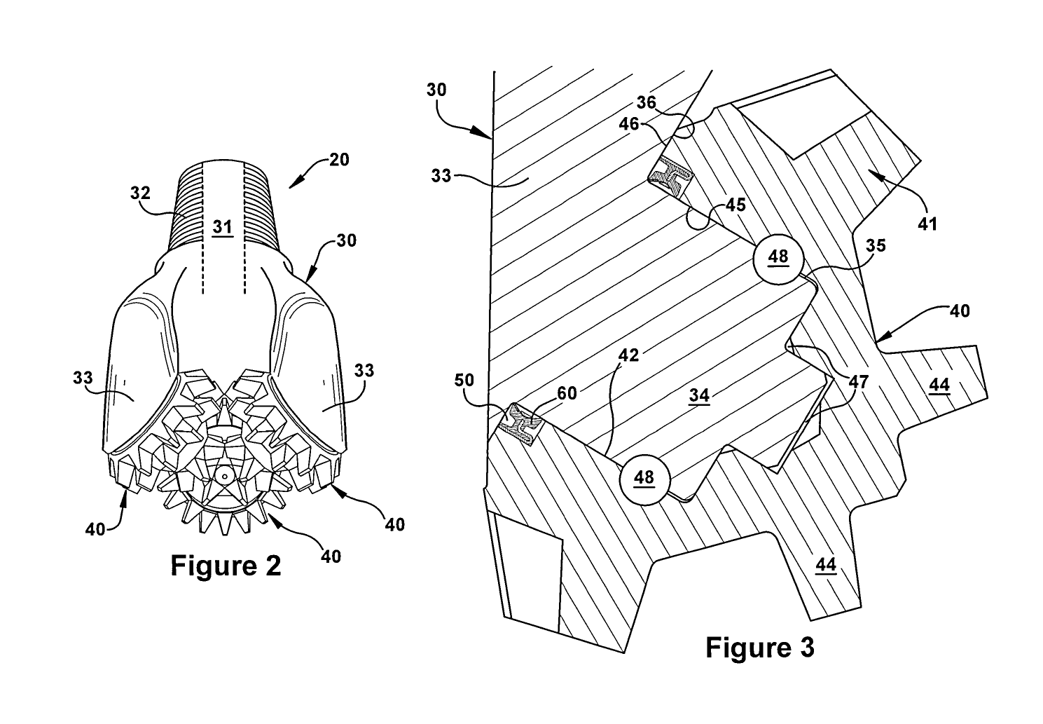

The drillbit 20, shown isolated from the rest of the drillstring 13 in FIG. 2, can comprise a hub 30 having a central passageway 31 and a threaded fitting 32 connected to the drillstring's lower end. The hub's passageway 31 forms an extension of the downward mud passage 15 in the drillstring 13, and the drilling fluid is pumped therethrough into the wellbore 11.

The hub 30 also includes one or more arms 33. And the drillbit 20 includes a cutter 40 rotatably mounted on each arm 33. The illustrated drillbit 20 has three cutters 40 and thus its hub 30 has three arm portions 33. The cutters 40 can be spaced approximately 120° about the axis of the hub 30 and can face towards each other. Such a triple-cutter or tri-cutter design is popular, as it is believed to efficiently and effectively confront ground matter during the drilling process. That being said, a drillbit with less (e.g., one or two) or more (e.g., four, five, etc.) cutters 40 and/or arms 33 is certainly possible and contemplated.

As is best seen by referring additionally to FIG. 3, each arm 33 comprises a spindle 34 around which the corresponding cutter 40 rotates. And each cutter 40 can comprise a head 41 having a bore 42 for receipt of this spindle 34. The cutter 40 and/or the head 41 can also include external projections 44 for aggressive interaction with terrain engaged during the drilling process.

The hub 30 can have cutter-interfacing surfaces that interface with the cutter 40 and the cutter 40 can have hub-interfacing faces that interface with the hub 30. In the illustrated drillbit 20, for example, the cutter-interfacing surfaces of the hub 30 can include the exterior cylindrical surface 35 of the spindle 34, and the planar surface 36 of the spindle-surrounding ledge. The hub-interfacing surfaces of the cutter 40 can include the interior cylindrical surface 45 of the spindle-receiving bore 42 and the planar surface 46 of the bore-surrounding ledge. Adjacent interfacing surfaces (e.g., surfaces 35 and 45, and/or surfaces 36 and 46) spin (i.e., rotate) relative to one another. Interfacing surfaces can be oriented concentric to the rotating axis of the cutter 40 (e.g., interfacing surfaces 35 and 45), perpendicular to the rotating axis of the cutter 40 (e.g., interfacing surfaces 36 and 46), or in any other appropriate orientation for the drillbit design.

A lubricant-containing cavity 47, also housing bearings 48 (e.g., ball bearings), occupies the space between interfacing surfaces of each arm 33 and the cutter 40 rotatably mounted thereon.

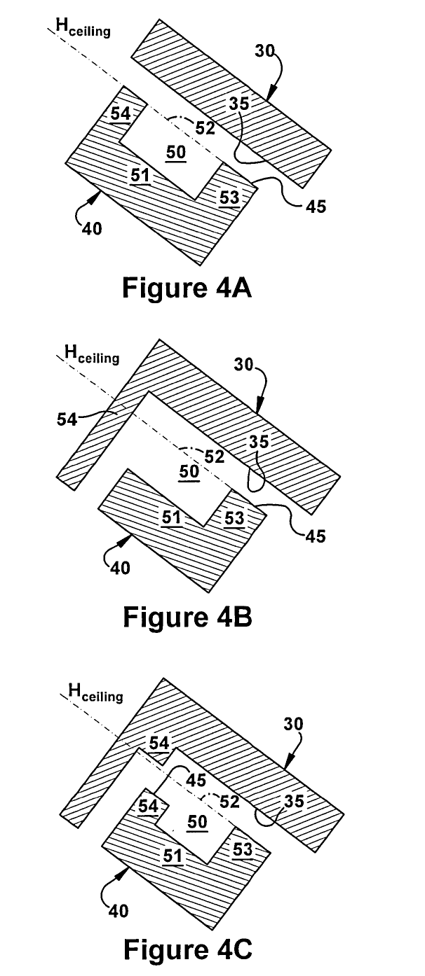

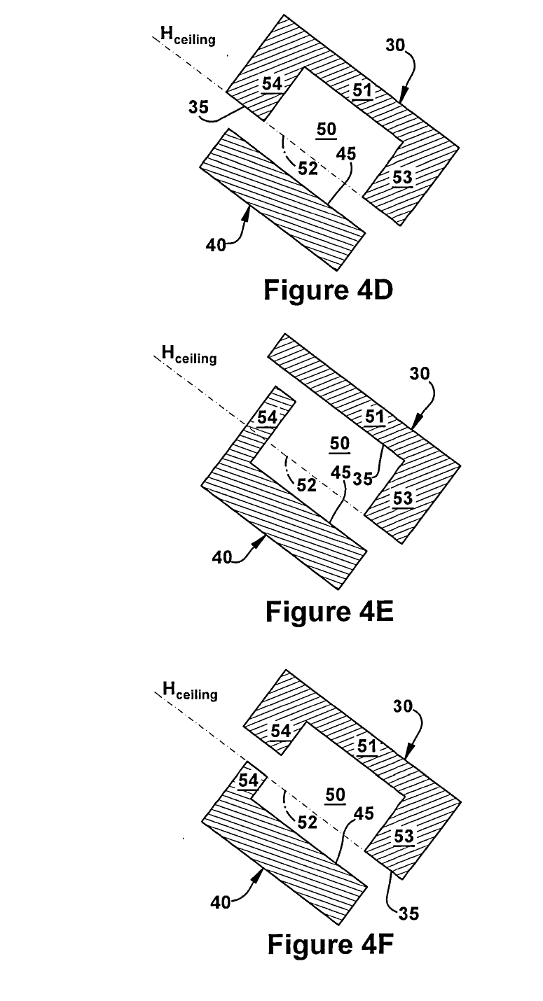

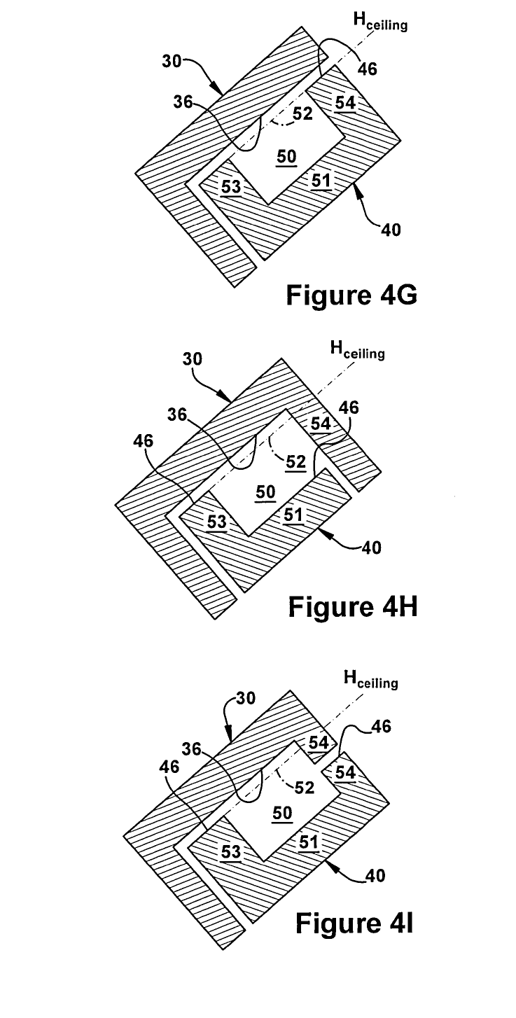

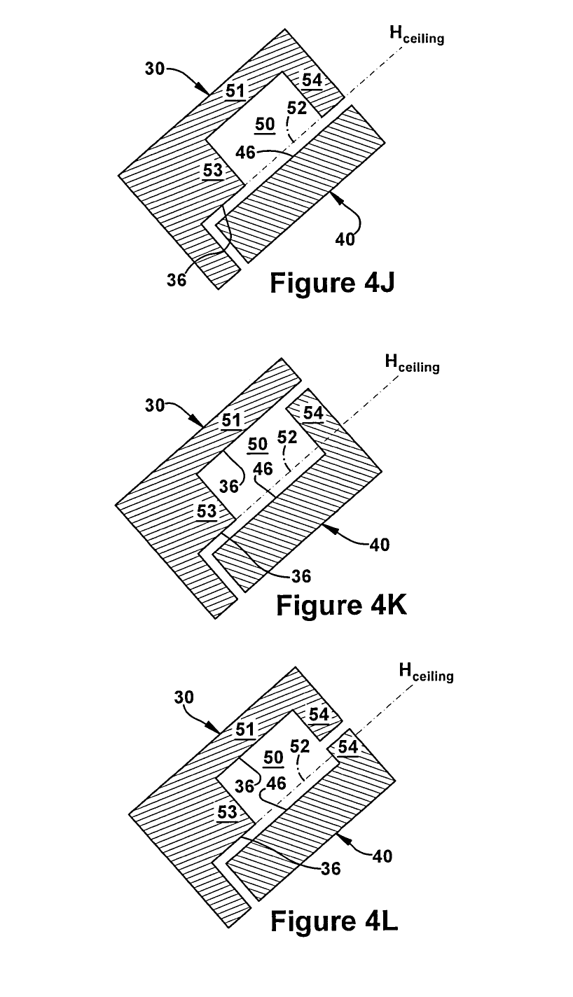

A seal-receiving envelope 50 is situated between an interfacing surface of the hub 30 and an interfacing surface of the cutter 40. The envelope 50 has an annular shape (in plan) with a roughly rectangular cross-section. As is best seen by referring additionally to the 4^{th} set of drawings (FIGS. 4A-4L), the envelope 50 can have a floor 51, an open ceiling 52, an inboard wall 53, and an outboard wall 54. The floor 51 forms the bottom, or base of the envelope 50. The ceiling 52 is spaced from the floor 51 by a height H_{ceiling} defined by the inboard wall 53. The inboard wall 53 is closest to the lubricant-containing cavity 47 (e.g., lubeside) and the outboard wall 54 is closest to the exterior of the drillbit 20 (e.g., mudside).

In the illustrated drillbit 20, the envelope 50 is situated between the interfacing surface 35 (the exterior surface of the spindle 34) of the hub 30 and the interfacing surface 45 (the surface defining the bore 42) of the cutter 40. (See e.g., FIGS. 4A-4F.) In this arrangement, the floor 51 is radially spaced from the ceiling 52, and the inboard wall 53 is axially spaced from the outboard wall 54.

The envelope 50 could instead be situated between other hub-cutter interfacing surfaces. For example, the envelope 50 can be situated between the interfacing surface 36 (the spindle-surrounding ledge) of the hub 30 and the interfacing surface 46 (the bore-surrounding ledge) of the cutter 40. (See e.g., FIGS. 4G-4L.) In this arrangement, the floor 51 would be axially spaced from the ceiling 52 and the inboard wall 53 would be radially spaced from the outboard wall 54.

The envelope's floor 51 and its inboard wall 53 can be formed in an interfacing surface of the cutter 40 (e.g., surface 45 or surface 46). If so, the envelope's outboard wall 54 can be formed in the same cutter surface and/or by an interfacing surface of the hub 30 (e.g., surface 35 or surface 36). (See e.g., FIGS. 4A-4C and/or FIGS. 4G-4I.) The envelope's floor 51 and its inboard wall 53 could instead be formed in an interfacing surface of the hub 30 (e.g., surface 35 or surface 36), and its outboard wall 54 could be formed by the same hub surface and/or by an interfacing surface of the cutter 40 (e.g., surface 45 or surface 46). (See e.g., FIGS. 4D-4F and FIGS. 4J-4L.) In an envelope construction with the floor 51 formed in the cutter 40 (whereby the floor 51 rotates with the cutter 40 relative to the hub 30), the ceiling 52 is positioned adjacent a non-rotating surface 35/36 of the hub 30. In an envelope construction with the floor 51 formed in the hub 30 (whereby the floor 51 stays with hub 30 as the cutter 40 rotates therearound) the envelope's ceiling 52 is positioned adjacent a rotating surface 45/46 of the cutter 40. In either or any case, the open ceiling 52 of the envelope 50 will be positioned adjacent an interfacing surface that spins relative to the envelope 50, or an “interfacing spin surface.”

A seal 60 is installed in the envelope 50 to seal the interface between the hub 30 and the cutter 40. The seal 60 must prevent escape of lubricant from the bearing cavity 47 and must prevent entry of mud with ground dirt and rock (or other foreign material) into this cavity 47. Insufficient lubrication and/or intolerable mud invasion will almost always lead to drillbit failure, whereby if the seal 60 falters, the drillbit 20 must be replaced or repaired. Replacement/repair of a drillbit component can require tripping of the drillstring 13 which, as explained above, can seriously impact a drilling operation's productivity. Thus, it is important that the seal 60 not only perform adequately, but also that preferably has a useful life at least as long as the other drillbit components.

That being said, the seal 60 does not live a sheltered life. During normal drilling conditions, pressurized (and abrasive) mud is continuously being ejected at or near the outboard wall 54 of the envelope 50. And if that is not bad enough, the seal 60 must also be built to withstand undesirable (but often unavoidable) conditions. For example, the seal 60 must be ready to confront forces caused by over-pressure problems in the lubricant-containing cavity 47 and/or abnormal force swells in the wellbore 11.

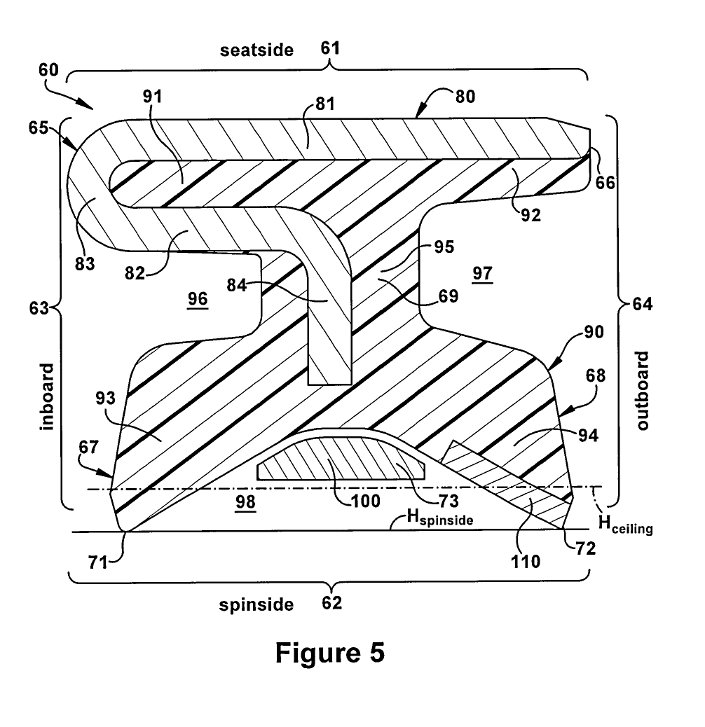

The seal 60 is shown isolated from the rest of the drillbit 20 in FIG. 5. The seal 60 has a seatside face 61, a spinside face 62, an inboard face 63, and an outboard face 64. The faces 61-64 correspond to the installation of the seal 60 within the envelope 50. Specifically, the seatside face 61 seats against the envelope's floor 51, the spinside face 62 projects beyond the envelope's ceiling 52 toward the interfacing spin surface, the inboard face 63 is positioned adjacent the envelope's inboard wall 53, and the outboard face 64 is positioned adjacent to the envelope's outboard wall 54. Using this convention, the seal 60 can be viewed as having an IBseat region 65, an OBseat region 66, an IBspin region 67, an OBspin region 68, and a central region 69.

The IBseat region 65 is a rigid region, the IBspin region 67 is flexible region with a lip 71, and the OBspin region 68 is a flexible region with a lip 72. The primary function of the IBspin lip 71 is to prevent leakage from the lubricant-containing cavity 47 and to maintain its internal pressure. The primary function of the OBspin 72 lip is to prevent ingress of mud into the lubricant-containing cavity 47.

When the seal 60 is an uncompressed state, the outermost projection on its spinside face 62 projects beyond the ceiling 52 of the envelope 50 and defines a height H_{spinside}. Both the lip 71 and the lip 72 project towards the height H_{spinside} and at least one of these lips contains the height-defining projection. If the envelope's ceiling 52 is positioned radially/axially inward from its floor 51 (see e.g., FIGS. 4A-4C and/or FIGS. 4G-4I), the height H_{spinside} of the seal is positioned radially/axially inward therefrom. If the envelope's ceiling 52 is positioned radially/axially outward from its floor 51 (See e.g., FIGS. 4D-4F and/or FIGS. 4J-4L), the height H_{spinside} of the seal is positioned radially/axially outward therefrom. In either or any event, the lips 71 and 72 each have a flexibility that allows compression yet resists deformation in normal operating pressures.

The seal 60 further comprises a rigid bridge region 73 extending between the spinside lips 71 and 72. The lip-bridging region 73 does not project to the height H_{spinside} of the seal 60 and, when the seal is installed in the envelope 50, it does not project to the height H_{ceiling} of the ceiling 52.

The purpose of the bridge region 73 is to provide support to the lips 71/72 when either or both internal pressure (e.g., inside the lubricant-containing cavity 47) and external pressure (e.g., outside the drillbit 20) reach abnormal levels. For example, to prevent over-bulging of the seal's flexible spinside regions 93/94, the bridge region 73 is pushed outward by the regions' reshaping and engages the interfacing spin surface (e.g., surface 35/45). This engagement braces the lips 71/72 and limits their contact with the interfacing spin surface, thereby guarding against deformation leading to excessive lip contact.

The seal 60 can comprise a rigid carrier 80, an elastomeric body 90 bonded to the rigid carrier 80, and a reinforcing band 100. The rigid carrier 80 is made from a rigid material that will not compress or otherwise significantly deform at expected seal conditions. The carrier 80 can, for example, be made of metal (e.g., steel, cold-rolled steel) and/or formed in one-piece (e.g., by stamping).

The rigid carrier 80 can have a cross-section shape that, in the illustrated seal 60, is formed by a spinside leg section 81, a leg section 82, a U-turn corner section 83, and a tail section 84. The leg section 81 at least partially spans the seal's seatside face 61 and can almost completely spans this face 61. The secondary leg section 82 is positioned parallel to the primary leg section 81 and is offset therefrom in the spinside direction. The corner section 83 connects the inboard edges of the legs 81 and 82. The tail section 84 extends perpendicularly (in the spinside direction) from the outboard edge of the leg 82.

The elastomeric body 90 can be a one-piece body formed by, for example, compression molding, and it can be joined to the rigid carrier 80 during the molding process. The elastomeric material can be selected based on expected drilling conditions (e.g., speed, temperature, pressure, drilling fluid, etc.). Suitable candidates can include FKM (fluorinated elastomers), NBR (nitrile butadiene rubbers), HNBR (hydrogenated acrylonitrile-butadiene rubber), XNBR (carboxylated nitrile rubbers), and/or HXNBR (hydrogenated carboxylated acrylonitrile-butadiene rubber).

The elastomeric body 90 can comprise an IBseat portion 91, an OBseat portion 92, an IBspin portion 93, an OBspin portion 94, and a central portion 95. An inboard groove 96 separates the inboard portions 91 and 93 of the elastomeric body 90 (and also the inboard regions 65 and 66 of the seal 60). An outboard groove 96 separates the outboard portions 92 and 94 of the elastomeric body 90 (and also the outboard regions 66 and 68 of the seal 60). A spinside groove 98 separates the spinside portions 93 and 94 of the elastomeric body 90 (and also the spinside regions 65 and 66 of the seal 60). In the illustrated seal 60, the outboard/inboard grooves 96 and 97 are relatively narrow and deep, while the spinside groove 98 is relatively long and shallow.

The IBseat portion 91 of the elastomeric body 90 is positioned within the space defined by sections 81-83 of the rigid carrier 80 (e.g., primary leg section 81, secondary leg section 82, and corner section 83). This portion 81 and these sections 81-83 form the seal's rigid IBseat region 65, that seats against the envelope's floor 51 and its inboard wall 53. This creates a strong static seal insuring that the seal 60 will not turn within the envelope 50 during rotation of the cutter 40. If the envelope's floor 51 and inboard wall 53 are metal (as they usually are), and the carrier 80 is metal, a metal-to-metal pressfit and/or seat is created that is less likely to loosen at high temperatures.

Depending upon the envelope's orientation, the seal's overall radial compressibility, and/or the drillbit design, seating of the rigid IBseat region 65 may require an open-outboard-wall construction, such as shown in FIGS. 4B and 4E. That is, when the envelope's floor 50 and its inboard wall 53 are formed in the cutter 40, the outboard wall 54 is formed (or at least partially formed) in the hub 30. Likewise, when the envelope's floor 50 and its inboard wall 53 are formed in the hub 30, the outboard wall 54 is formed (or at least partially formed) in the cutter 40. For example, with the envelope construction shown in FIGS. 4A and 4D, the seal's diameter would need to be decreased by twice the ceiling height H_{ceiling} for insertion into the envelope 50. A lesser amount of radial compression would be necessary for the envelope construction shown in FIGS. 4D and 4F. With the envelope constructions shown in FIGS. 4G-4J (wherein the floor 51 and ceiling 52 are axially spaced), this may not be such a concern. It should be noted that the outboard wall 53 could be constructed by an additional part attached to the floor 51.

The rigid IBseat region 65 and/or the rigid carrier 80 also provide a stable support stage for the inboard lips 71 and 72. Specifically, the region 65 trusses the lips 71 and 72 in the correct orientation (i.e., perpendicular to the seal axis) and/or it prevents twisting of the spinside portions 93/94 of the elastomeric body 90 when interfacing with the spin surface. In this manner, lip stability is provided without sacrificing the flexibility of the seal's spinside regions 67 and 68.

Further support and stability can be provided by the seal's central region 69 which comprises the tail section 84 of the rigid carrier 80 and the central portion 95 of the elastomeric body 90. If the tail section 84 is embedded in or otherwise anchored relative to the central portion 95, this section 84 can function as a circumferential spine for the seal 60. And the orientation of the tail section 84 parallel to the lip-projection direction encourages pivoting and/or enhances the flexibility of the spinside regions 67/68 and/or the lips 71/72.

The reinforcing band 100 at least partially forms the lip-bridging region 73 between the spinside lips 71 and 72. The reinforcing band 100 can be a separate insert added to the seal structure after the molding of the elastomeric body 90 and/or bonding of the body 90 to the rigid carrier 80. Additionally or alternatively, the band 100 can be formed during the molding of the elastomeric body 90 and/or be partially formed by an extension of the rigid carrier 80.

The reinforcing band 100 is made of material more rigid than the elastomeric body 90, and can comprise, for example, a hard plastic and/or a plastic coated metal. The band material can also be (but need not be) a self-lubricating material and thus also function as lip-lubricating means. For example, virgin or lightly filled PTFE could be used as the band material to thereby provide both a fortress bridge and lubricating film. In either or any event, the band's seatside profile can be curved to fit within the shallow spinside groove 98 of the elastomeric body 90 and the band's spinside profile can be planar to firmly engage the interfacing spin surface should abnormal pressures cause it to bulge beyond the envelope's ceiling 52.

The seal 60 can further include a reinforcing canopy 110 for its outboard (spinside) lip 72. The reinforcing canopy 110 can be an insert bonded to the seal structure after elastomeric molding and/or it can be adhered during or after a molding process. The canopy 110 provides abrasion-resistance, friction-reduction, and/or physical strength to the outboard lip 72 to aid in its ongoing battle to exclude exterior fluid (e.g., mud) from the lubricant-containing cavity 47. With the proper selection of canopy material, lip reinforcement can be done without compromising lip lubrication. For example, the canopy material can be PTFE filled with reinforcing materials (e.g., glass fibers and/or graphite). As the reinforcement canopy 110 need only occupy the contacting surface of the lip 72, an annular strip or ring can be sufficient.

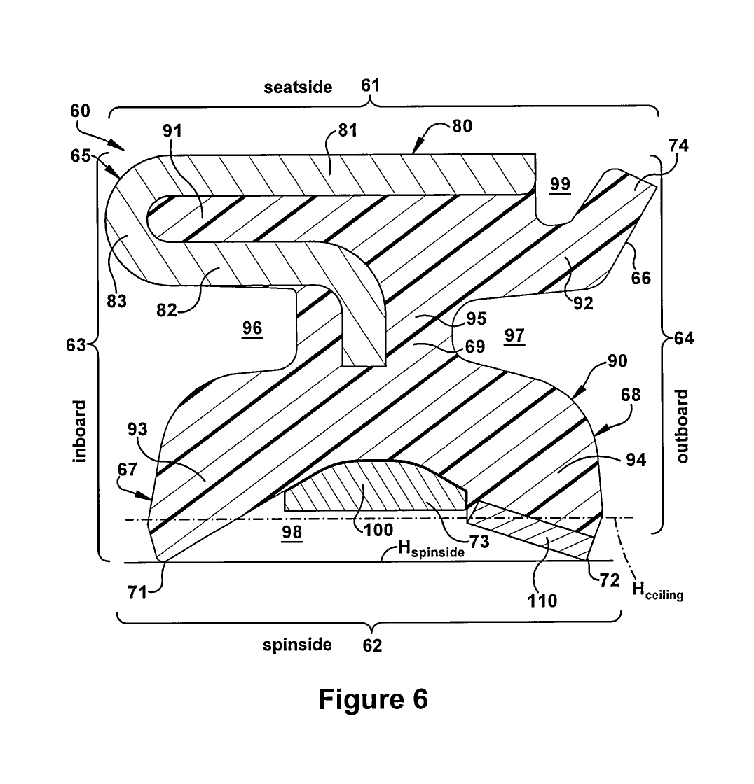

The seal 60 can further include a seatside lip 73, such as is shown in FIG. 6. The seatside lip 74 can be formed by the OBseat portion 92 of the elastomeric body 90 and a groove 99 can separate the lip 74 from the rest of the seatside portions 91/92. The carrier's leg section 81 can extends to the inboard edge of the groove 99 to thereby maintain seatside rigidity. The lip 74 can serve as a preliminary mud shield and/or throttle so that the OBspin lip 72 is subjected to less abrasion and/or fewer pressure spikes.

One may now appreciate that the drillbit seal 60 comprises a rigid region 65 for forming a static seat against the envelope floor 51, flexible lipped regions 67/68 in consistent sealing contact with the interfacing spin surface, and a reinforcing region 73 bridging between spinside lips 71/72. Although the drillbit 20, the envelope 50, and/or the seal 60 has been shown and described with respect to certain embodiments, it is obvious that equivalent alterations and modifications will occur to others skilled in the art upon the reading and understanding of this specification and the annexed drawings. In regard to the various functions performed by the above described elements (e.g., components, assemblies, systems, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function. In addition, while a particular feature of the invention may have been described above with respect to only one or more of several illustrated embodiments, such feature may be combined with one or more other features of the other embodiments, as may be desired and advantageous for any given or particular application.

1. A seal having a seatside face, a spinside face spaced from the seatside face and defining a height H_{spinside}, an inboard face, and an outboard face spaced from the inboard face; said seal comprising:
a rigid carrier having a seatside leg section at least partially forming a rigid IBseat region for static seating within an envelope; and
an elastomeric body having an IBspin portion at least partially forming a flexible IBspin region with an IBspin lip, and an OBspin portion at least partially forming a flexible OBspin region with an OBspin lip; wherein the IBspin lip and the OBspin lip project towards the height H_{spinside} and at least one of these lips defines the height H_{spinside}.

2. A seal as set forth in claim 1, further comprising a reinforcing band at least partially forming a rigid bridge region between the IBspin lip and the OBspin lip, wherein the rigid bridge region does not project to or beyond the height H_{spinside}.

3. A seal as set forth in claim 1, further comprising a reinforcing canopy forming the spinside surface of the OBspin lip.

4. A seal as set forth in claim 1, wherein the rigid carrier is formed in one piece and comprises another leg section also forming part of the rigid IBseat region, and wherein the elastomeric body is formed in one piece and comprises an IBseat portion positioned between leg sections of the rigid carrier and forming part of the rigid IBseat region.

5. A seal as set forth in claim 1, wherein the elastomeric body comprises an IBseat portion forming part of the rigid IBseat region.

6. A seal as set forth in claim 1, wherein the rigid carrier comprises a tail section formed in one piece with the spinside leg section, and wherein the elastomeric body comprises a central portion in which the tail section is embedded.

7. A seal as set forth in claim 1, wherein the elastomeric body is formed in one piece and also comprises an OBseat portion forming an OBseat region with an OBseat lip.

8. A seal as set forth in claim 1, wherein the elastomeric body is formed in one piece and further comprises an IBseat portion, a groove between the IBspin portion and the IBseat portion, an OBseat portion, and a groove between the OBspin portion and the IBseat portion.

9. A seal as set forth in claim 1, wherein the rigid carrier is made of metal.

10. A seal as set forth in claim 1, wherein the reinforcing band is made of rigid material that also self lubricates.

11. A seal as set forth in claim 1 installed in a component that defines a floor and an inboard wall of an annular envelope having a roughly rectangular cross-sectional shape, wherein the seal's rigid IBseat region is statically seated against the envelope's floor and its inboard wall.

12. A seal as set forth in the claim 11, wherein the rigid carrier is made of metal, wherein the floor and the inboard wall are metal, and wherein the IBseat region is metal-to-metal pressfit into the envelope.

13. A seal for receipt within an annular envelope having a roughly rectangular cross-sectional shape defined by a floor, an open ceiling spaced from the floor by a height H_{ceiling} defined by an inboard wall, said seal comprising:
an elastomeric body having a portion at least partially forming a flexible IBspin region with an IBspin lip that projects beyond the height H_{ceiling} in an uncompressed state, and a portion at least partially forming a flexible OBspin region with an OBspin lip that projects beyond the height H_{ceiling} in an uncompressed state; and
a reinforcing band at least partially forming a rigid bridge region between the IBspin lip and the OBspin lip, wherein the rigid bridge region does not project beyond the H_{ceiling}.

14. A seal as set forth in claim 13, further comprising a rigid carrier having a seatside leg section at least partially forming a rigid IBseat region for static seating against the floor and the inboard wall of the envelope.

15. A seal as set forth in claim 14, wherein the rigid carrier is made of metal.

16. A seal as set forth in claim 13, further comprising a reinforcing canopy occupying the spinside surface of the OBspin lip.

17. A seal as set forth in claim 13 installed in an annular envelope having a roughly rectangular cross-sectional shape defined by a floor and an open ceiling spaced from the floor by a height H_{ceiling}, defined by an inboard wall;
wherein IBspin lip and the OBspin lip project beyond the height H_{ceiling} in an uncompressed state; and
wherein the rigid bridge region does not project beyond the H_{ceiling}.

18. A drillbit comprising:
an arm having a spindle;
a cutter mounted for rotation around the spindle;
a lubricant-containing cavity between the arm and the cutter, the cavity containing bearings to aid rotation of the cutter relative to the spindle and lubricant for such bearings;
an annular envelope between the arm portion and the cutter, the envelope having a roughly rectangular cross-section shape with a floor, and an open ceiling spaced from the floor,
an interfacing spin surface that spins relative to the envelope adjacent its open ceiling; and
the seal set forth in claim 12 installed in the envelope, wherein the IBspin lip and the OBspin lip contact and are compressed by the interfacing surface, and wherein the rigid bridge region does not contact the interfacing surface.

19. A drillbit as set forth in claim 18, wherein the seal further comprises a rigid carrier having a seatside leg section at least partially forming a rigid IBseat region that is statically seated against the floor and an inboard wall of the envelope.

20. A drillbit as set forth in claim 19, wherein the floor and the inboard wall of the envelope are metal, wherein the rigid carrier is made of metal, and wherein the IBseat region is metal-to-metal pressfit into the envelope.
